(19) United States
(12) Patent Application Publication
(10) Pub. No.: US 2004/0101802 A1
(43) Pub. Date: May 27, 2004

(54) Wide bandwidth led curing light

(76) Inventor: Robert R. Scott, Riverton, UT (US)

Correspondence Address: Rick D. Nydegger, WORKMAN, NYDEGGER & SEELEY, 1000 Eagle Gate Tower, 60 East South Temple, Salt Lake City, UT, 84111, US

(21) Appl. No.: 10/301,158

(22) Filed: Nov. 21, 2002

(51) Int. Cl. A61C 3/00

(52) U.S. Cl. 433/29

(57) ABSTRACT

A curing light incorporates a plurality of different types of LED light sources that are configured to emit different wavelengths. In one embodiment, the different LED light sources collectively emit a broad and broad spectrum of light that emulates the spectrum of light emitted by a quartz-halogen-tungsten bulb. Accordingly, the curing light may be used to cure camphorquinone initiated products as well as adhesives and other photocurable resins that cure at a wavelength different from the wavelength used to initiate curing of products that contain camphorquinone. The curing light may be configured to allow the different LED light sources to be operated simultaneously or separately as desired. Any number of LED light sources may be utilized by the curing light. In one embodiment, the LED light sources are disposed and arranged at the distal end of the curing light in such a manner that the light can be emitted from the LED light sources in an overlapping manner.

### BACKGROUND OF THE INVENTION

1. The Field of the Invention

The present invention generally relates to the field of light curing devices and, more specifically, to light curing devices utilizing light emitting diodes (LEDs).

2. The Relevant Technology

In the field of dentistry, dental cavities are often filled and/or sealed with photosensitive compounds that are cured by exposure to radiant energy, such as visible light. These compounds, commonly referred to as light-curable compounds, are placed within dental cavity preparations or onto dental surfaces where they are subsequently irradiated by light. The radiated light causes photosensitive components within the compounds to polymerize, thereby hardening the light-curable compounds within the dental cavity preparation or another desired location.

Existing light-curing devices are typically configured with a light source, such as a quartz-tungsten-halogen (QTH) lamp bulb or an LED light source. QTH bulbs are particularly useful because they are configured to generate a broad spectrum of light that can be used to cure a broad range of products. In particular, a QTH bulb is typically configured to emit a continuous spectrum of light in a preferred range of about 350 nm to about 500 nm. Some QTH bulbs may even emit a broader spectrum of light, although filters are typically used to limit the range of emitted light to the preferred range mentioned above.

One reason it is useful for the QTH bulb to emit a broad spectrum of light is because many dental compounds cure at different wavelengths. For example, camphorquinone is a common photo-initiator that is most responsive to light having a wavelength of about 460 nm to about 470 nm. Other light-curable products, however, including many adhesives are cured when they are irradiated by light wavelengths in the 350 nm to 400 nm range. Accordingly, QTH bulbs can be used to cure both camphorquinone initiated products as well as adhesives.

One problem with QTH bulbs, however, is that they generate a relatively high quantity of heat, making it impractical to place QTH bulbs on the portions of the light-curing devices that are inserted within the mouth of a patient. In particular, if the QTH bulbs were disposed at the tips of the light-curing devices, the heat generated by the QTH bulbs could burn or agitate the sensitive mouth tissues of the patient. Accordingly, the QTH bulbs are typically disposed remotely from the portion of the light-curing device that is inserted within a patient's mouth. The heat generated by QTH bulbs also represents wasted energy, which increases the power requirement to achieve a desired light intensity.

To channel and direct the light emitted by a QTH bulb to the desired location within a patient's mouth, existing curing lights must utilize light guides, such as fiber optic wands and tubular light guides, or special reflectors. Although fiber optic wands and reflectors are useful for their intended purposes, they are somewhat undesirable because they can add to the cost and weight of the equipment, thereby increasing the overall cost and difficulty of performing the light-curing dental procedures.

Another problem with existing light-generating devices is that they are not very efficient. In particular, large quantities of radiation energy is lost due to filtering, dissipation, and light that is not properly directed into the patient's mouth. This is a problem because it generally results in increased power requirements for generating a desired output of radiation. Another problem experienced by QTH light-curing devices, is that complicated cooling systems are often required to compensate for the heat that is generated when the unchanneled and unused light is absorbed by the special filters and reflective surfaces.

In an attempt to overcome the aforementioned problems, some light-generating devices have been manufactured using alternative light generating sources, such as light-emitting diodes (LEDs) which are generally configured to only radiate light at specific wavelengths, thereby eliminating the need for special filters and generally reducing the amount of input power required to generate a desired output of radiation.

LEDs are particularly suitable light sources because they generate much less heat than QTH bulbs, thereby enabling the LEDs to be placed at the tip of the curing lights and to be inserted directly within the patient's mouth. This is particularly useful for reducing or eliminating the need for light guides such as optical fiber wands.

One limitation of LEDs, however, is that they are only configured to emit a narrow spectrum of light. For example, a 460 nm LED or LED array will generally only emit light having a spectrum of 460 nm±30 nm. Accordingly, a light curing device utilizing a 460 nm LED light source will be well designed to cure camphorquinone initiated products, but will not be suitable for curing adhesives that are responsive to light in the 400 nm±30 nm range. Likewise, a light-curing device utilizing a 400 nm light source may be suitable to cure some adhesives, but will be unsuitable for curing camphorquinone initiated products.

In view of the foregoing, there exists a need to develop dental curing lights that include multiple LEDs that emit at different wavelengths in order to provide a broader spectrum of light at more than the dominant wavelength of a single LED.

### SUMMARY OF THE INVENTION

Briefly summarized, the embodiments of the present invention are directed to improved curing lights that utilize a plurality of light-emitting diodes (LED)s to generate a broader spectrum of radiant energy compared to a single LED.

According to one embodiment, the curing lights of the invention include a plurality of different LED light sources, at least two of which are selected to emit a continuous spectrum of light. When the plurality of LED light sources are operated at the same time, they create a desired spectrum of light, e.g., in order to emulate or approximate the spectrum of light emitted by a quartz-tungsten-halogen (QTH) bulb, but without generating the level of heat emitted by a QTH bulb.

According to another aspect of the invention, the light sources are disposed on the distal end of the curing light in such a manner that the LED light source can be inserted within a patient's mouth to directly irradiate the desired location within the patient's mouth. According to one embodiment, the plurality of LED light sources are arranged on opposing faces at the distal end of the curing light in such a manner that the light emitted from the LED light sources is configured to overlap when the LED light sources are illuminated at the same time.

In some cases, a relatively large number of LEDs may be used, such as 5, 10, 20, 30 or 50 or more LEDs, some or all of which emit at different wavelengths. In the case where it would be impractical to place a large number of LEDs at the end of the curing light, the light emitted by the multiple LEDs can be collected and transmitted using a standard light guide.

In certain circumstances, it may be desirable to selectively turn on and off the individual LED light sources to enable the LED light sources to be activated singly or simultaneously. Controls for turning on and off the LED light sources may be located directly on the body of the curing light.

These and other benefits, advantages and features of the present invention will become more full apparent from the following description and appended claims, or may be learned by the practice of the invention as set forth hereinafter.

### BRIEF DESCRIPTION OF THE DRAWINGS

In order that the manner in which the above recited and other benefits, advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a graph charting the spectral irradiance of a 400 nm LED, a 430 nm LED, a 460 nm LED and a quartz Halogen Tungsten (QTH) bulb;

FIG. 2 illustrates one embodiment of a curing light of the invention that includes two different LED light sources that are disposed at the distal end of the curing light;

FIG. 3 illustrates a graph charting the spectral irradiance of blended light emitted from a 400 nm LED and a 460 nm LED;

FIG. 4 illustrates a graph charting the spectral irradiance of blended light emitted from a 430 nm LED and a 460 nm LED;

FIG. 5 illustrates one embodiment of a curing light of the invention that includes three different LED light sources that are disposed at the distal end of the curing light; and

FIG. 6 a graph charting the spectral irradiance of blended light emitted from a 400 nm LED, a 430 nm LED and a 460 nm LED.

### DETAILED DESCRIPTION OF THE PREFERRED EMBODIMENTS

A detailed description of the optical devices of the invention will now be provided with specific reference to figures illustrating various embodiments of the optical devices. It will be appreciated that like structures will be provided with like reference designations.

To help clarify the scope of the invention, certain terms will now be defined. The term “LED light source,” as used herein, generally refers to one or more LEDs, one or more LED arrays, or any combination of the above that is capable of generating radiant energy that can be used to cure light curable compounds. The light emitted by an LED light source includes a limited spectrum of wavelengths that corresponds with the rating of the LED light source.

The term “continuous spectrum of light,” as defined herein, refers to a spectrum of light that collectively includes substantially every wavelength of light within defined limits or range of the spectrum.

According to one embodiment, the light-curing devices of the invention are configured with at least two different types of LED light sources that are configured to emit different light spectra. In one embodiment, the different light spectra emitted by the plurality of different LED light sources create a continuous spectrum of light that emulates as the spectrum of light produced by a standard quartz-tungsten-halogen bulb.

The term “emulate,” is used herein, to suggest significant similarity, not necessarily exactness. Accordingly, even though the plurality of LED light sources may be configured to produce a continuous spectrum of light that “emulates” the spectral range of light produced by a QTH bulb, it is not necessary that the intensity of light produced by the LED light sources and the QTH bulb be the same at each wavelength within said spectral range. According to one embodiment, the spectral range of light produced by a standard QTH bulb is from about 360 nm to about 510 nm.

According to another embodiment, the curing light is configured with LED light sources configured to only emit light having wavelengths that are utilized for curing photo-sensitive compounds, rather than emitting a continuous spectrum that includes unused wavelengths. In some cases it may be advantageous to include two or more LEDs that emit at wavelengths that are sufficiently close together that their spectra overlap so as to emit a continuous spectrum of light, together with one or more LEDs that emit at noncontiguous wavelengths such that the overall spectrum emitted by the curing light is noncontinuous.

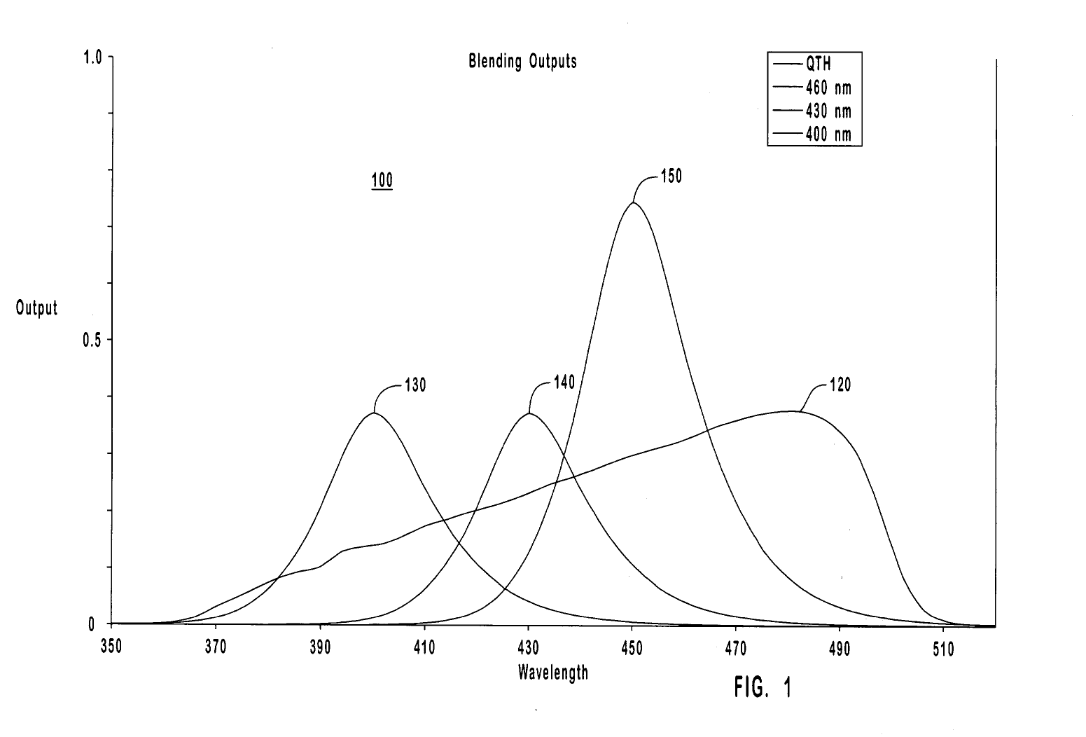

FIG. 1 illustrates a graph 100 that charts the spectral irradiance or light spectra emitted from by a quartz-tungsten-halogen (QTH) bulb, a 400 nm LED light source, a 430 nm LED light source, and a 460 nm LED light source. The values given in the y-axis are generic such that no specific representation as to the actual power output should be assumed.

As shown in FIG. 1, the QTH spectrum 120 ranges from about 360 nm to about 510 nm. The 400 nm LED spectrum 130 ranges from about 360 nm to about 450 nm, with the most intense output of light being within the range of about 380 nm to about 420 nm. The 430 nm LED spectrum 140 ranges from about 390 nm to about 480 nm, with the most intense output of light being within the range of about 410 nm to about 450 nm. The 460 nm LED spectrum 150 ranges from about 410 nm to about 510 nm, with the most intense output of light being within the range of about 430 nm to about 480 nm.

Also shown, each of the individual LED spectra 130, 140, and 150 individually comprise only a portion of the spectral range of wavelengths emitted by QTH spectrum 120. Accordingly, the utility of the LED spectra 130, 140 and 150 is somewhat more specialized or limited than the spectral irradiance of the QTH spectrum 120. In particular, the QTH spectrum 120 can be used to cure adhesives that are responsive to light at about 370-390 nm, as well as camphorquinone initiated products that are responsive to light at about 460 nm. In contrast, none of the individual LED spectra 130, 140 or 150 can be used to cure both camporquinone initiated products with 460 nm light as well as adhesives with 370-390 nm light.

Accordingly, QTH bulbs have greater utility than individual LEDs from the standpoint of providing light in a broad spectrum. However, as mentioned above, the heat generated by QTH bulbs is undesirable and effectively prevents the QTH bulb from being placed on the portion of the light-curing device that is inserted within a patient's mouth, thereby requiring QTH bulb devices to be utilized with light-guides to direct the light to the desired location within a patient's mouth. In contrast, LED light sources can be placed directly on the ends of light-curing devices and inserted within a patient's mouth. LEDs, however, emit only a narrow spectrum of light, effectively limiting their use to photo-curing a limited range of products, as compared to the broader range of products that can be cured using a QTH bulb. This limitation has generally required existing LED light-curing devices to be configured to cure only one of either camphorquinone initiated products or adhesives.

To overcome this limitation, the curing lights of the present invention are configured with a plurality of different types of LED light sources, as described below, to generate a composite and broad spectrum of light that is broader than a spectrum of light provided by any single LED light source. As described below, the LED light sources are also disposed at the distal end of the curing light and in such a manner as to enable the LED light sources to be placed within the mouth of a patient and to directly irradiate a desired treatment area, without the use of light wands or other tubular light guides. As further described below, the LED light sources can be arranged and configured to emit light in overlapping patterns.

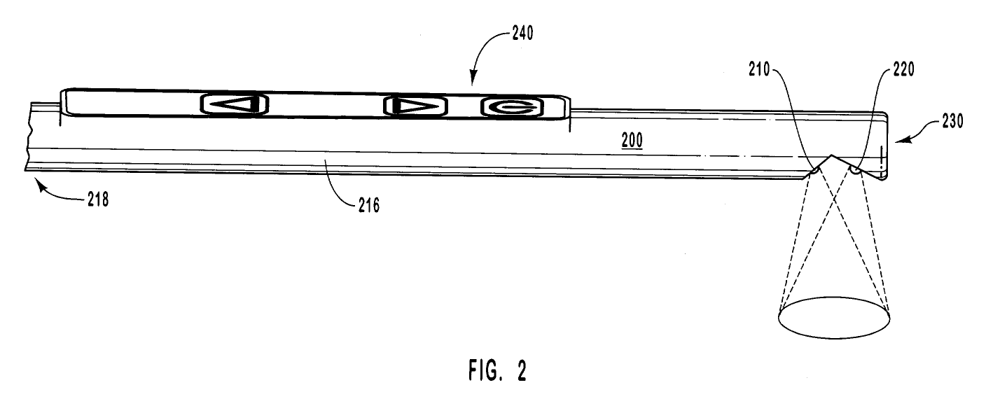

FIG. 2 illustrates one embodiment of a curing light 200 that has been configured with two LED light sources 210 and 220. As shown, the curing light includes a body 216 that is configured to be held in the hand of a dental practitioner and that extends from a proximal end 218 to a distal end 230. According to one embodiment, the LED light sources 210 and 220 are disposed at the distal end 230 of the curing light 200 in such a manner that they are configured for insertion within the mouth of a patient. The LED light sources are also mounted to emit the light somewhat orthogonally away from the body of the curing light. It will be appreciated that this can be a useful attribute of the curing light 200 for eliminating any requirement for ancillary light-guides. This, however, does not mean that the curing light 200 will not be used with lenses, which are distinguished from light-guides. Lenses may be used, for example, to focus the light from the LED light sources into more collimated beams or rather to disperse the light in some desired manner. Lenses or other devices can also be used to blend the light emitted from a plurality of LED light sources. A lens may, for example, be mounted at the distal end 230 of the curing light 200 over the LED light sources 210 and 220.

Furthermore, although the LED light sources 210 and 220 are shown mounted to opposing faces of the curing light 200, it will be appreciated that the LED light sources 210 and 220 can be mounted in any fashion or geometric arrangement on the curing light 200. One benefit of mounting the LED light sources 210 and 220 on opposing faces, as shown, is so that the light emitted by each of the LED light sources 210 and 220 will overlap in a predetermined manner, such that the LED light sources 210 and 220 can emit light to the same treatment surface at the same time. According to one embodiment, the light emitted from the LED light sources is configured to overlap at a distance of about 3 mm to about 10 mm away from the LED light sources.

Unlike existing curing light devices that are configured with only a single type of LED, the curing lights of the present invention are configured to incorporate different types of LED light sources. This does not mean, however, that the different types of LED light sources have to be operated at the same time. For instance, the LED light sources 210 and 220 may be selectively turned on and off at different times. In one embodiment, the curing light 200 is be configured with controls 240 disposed on the body of the curing light 200 that are configured to operably turn on the LED light sources 210 and 220 on or off, at the same time or at different times. The decision to use one or more types of LED light sources at the same time can depend on the photo-curing attributes of the one or more types of compounds that are being cured.

The different types of LED light sources 210 and 220 that are configured to be used with the curing light 200 may include LED light sources configured to emit the spectra 130, 140, and 150 illustrated and described above, with reference to FIG. 1, or any other light spectra.

According to one embodiment, the first LED light source 210 may include a 400 nm LED configured to emit a spectrum of light similar to spectrum 130 of FIG. 1 and the second LED light source 220 may include a 460 nm LED configured to emit a spectrum of light similar to spectrum 150 of FIG. 1. Of course the LED light sources 210 and 220 may be disposed in alternate locations on the curing light 200.

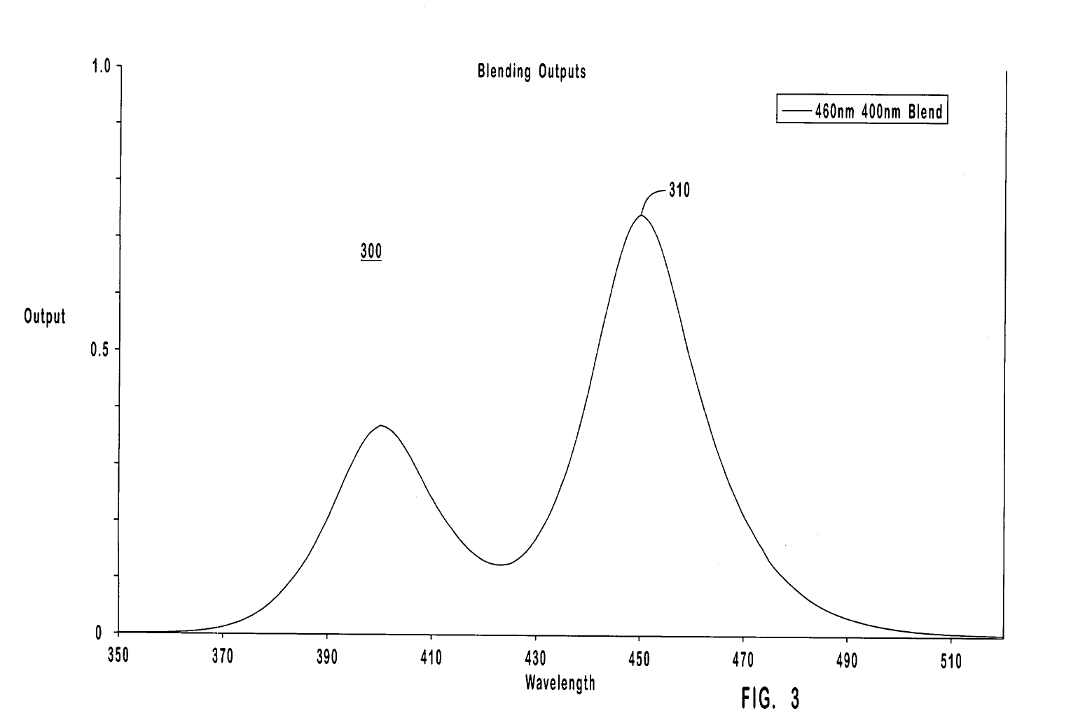

FIG. 3 illustrates a graph 300 charting the spectral irradiance of the blended light that is emitted from operating light source 210 and 220 at the same time. The output values given in the y-axis are generic. As shown, this broad spectrum 310 of light comprises a spectral range of light emulating the spectral range of light emitted by a QTH bulb. More particularly, the broad spectrum 310 of light created by the combination of the LED light sources 210 and 220 ranges from about 365 nm to about 515 nm, collectively including all wavelengths therebetween. This embodiment is useful for enabling the curing light 200 to cure the same compounds that can be cured by a QTH bulb. In particular, the curing light 200 can be used to cure camphorquinone initiated products with light having a frequency of about 460 nm as well as adhesives with light having a frequency of between about 360 nm and about 410 nm.

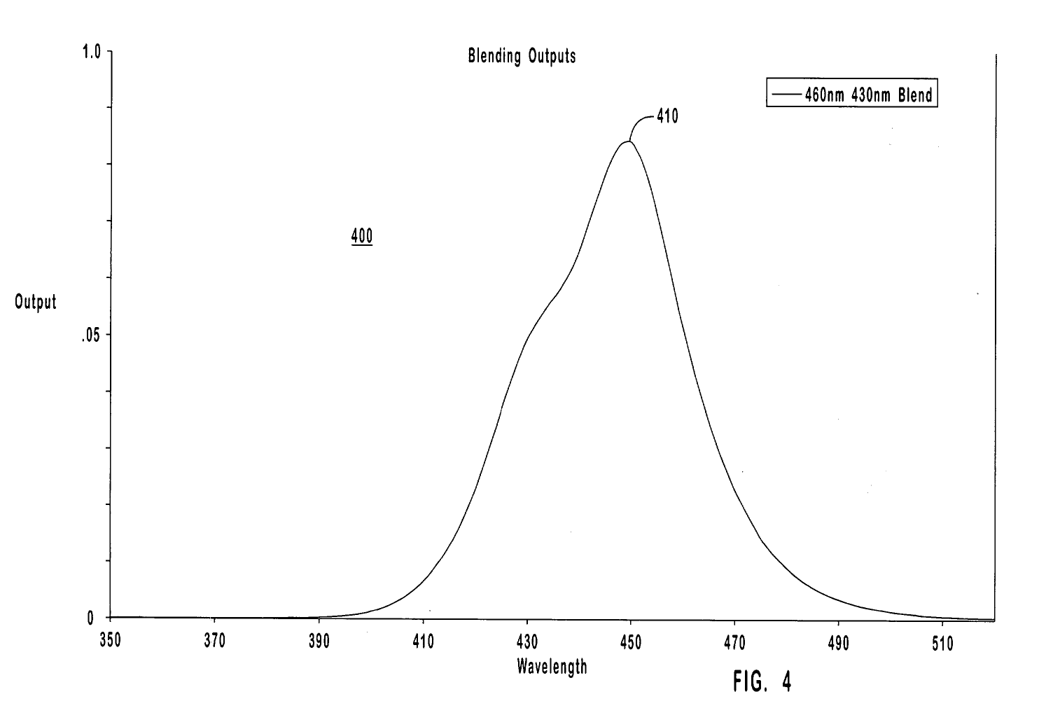

FIG. 4 illustrates another graph 400 of a broad spectrum 410 of light. This broad spectrum 410 of light comprises the composite wavelengths of light emitted by a 430 nm LED light source and a 460 nm LED light source. The output values given in the y-axis are generic. As shown, the broad spectrum 410 ranges from about 390 nm to about 510 nm, collectively including all wavelengths therebetween. This embodiment may be desired when the compound(s) being cured react most significantly to light in the 430 nm to 470 nm range, including camphorquinone initiated products. This embodiment may be particularly more practical for curing products in the 430 nm to the 440 nm range than the embodiment described above in reference to FIG. 3, for example, because the intensity of light produced by the present embodiment is greater in the 430 nm to the 440 nm range than it is for the embodiment charted in FIG. 3, thereby reducing the time that may be required for photo-curing.

Although the foregoing examples provide embodiments in which a curing light 200 may include two different types of LED light sources, it will be appreciated that the curing lights of the invention may also be configured with three or more different types of LED light sources, as described below.

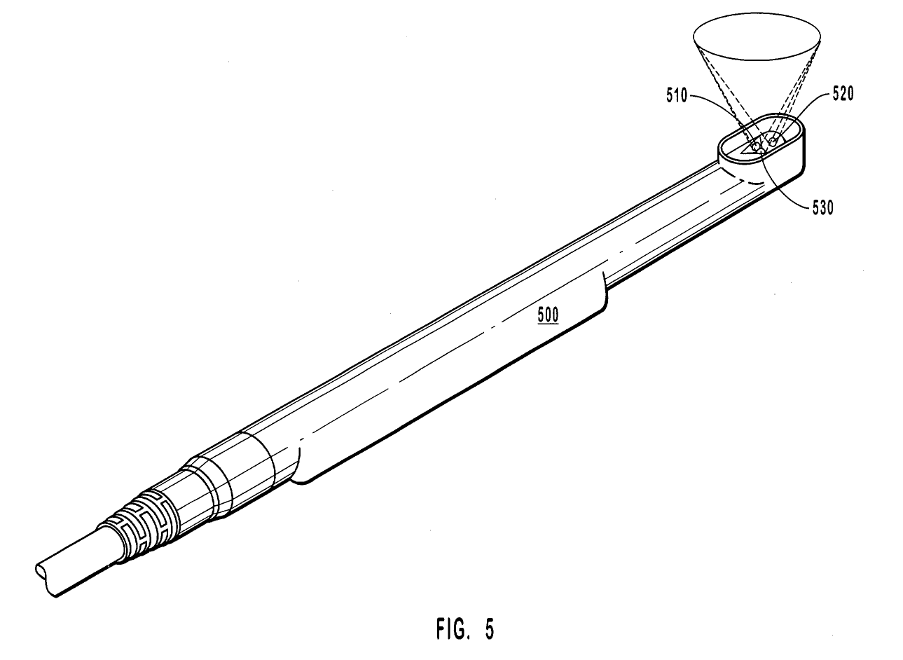

FIG. 5 illustrates a partial cross-sectional view of a curing light 500 that has been configured with three LED light sources 510, 520, 530 disposed at the tip of the curing light 500, which is configured to be inserted within the mouth of a patient. The output values given in the y-axis are generic. As shown, the LED light sources 510, 520 and 530 can be geometrically arranged and mounted on opposing faces to emit light in overlapping beams, as generally described above, although this is not required.

The LED light sources 510, 520 and 530 are each configured to emit different light spectra than the opposing LED light sources 510, 520 and 530, such that the collective spectral irradiance emitted from the plurality of LED light sources 510, 520 and 530 is greater than the spectral irradiance emitted independently from any one of the LED light sources 510, 520 and 530.

According to one embodiment, the LED light sources 510, 520 and 530 include a 400 nm LED, a 430 nm LED, and a 460 nm LED, such that the light produced by each of the individual LED light sources 510, 520 and 530 is comparable to the spectral irradiance of spectra 130, 140 and 150 charted in graph 100 of FIG. 1, respectively. Accordingly, the 460 nm LED can be used to cure camphorquinone initiated products. Likewise, the 400 nm LED may be used to cure adhesives. Although only three different types of LED light sources 510, 520 and 530 are shown, it will be appreciated that the curing light 500 may also be modified to include additional LED light-sources.

It will be appreciated that to conserve energy, the LED light sources 510, 520 and 530 can be turned on simultaneously or separately through controls (not shown) that are disposed on the curing light 500, to correspondingly satisfy the curing requirements of particular dental compositions.

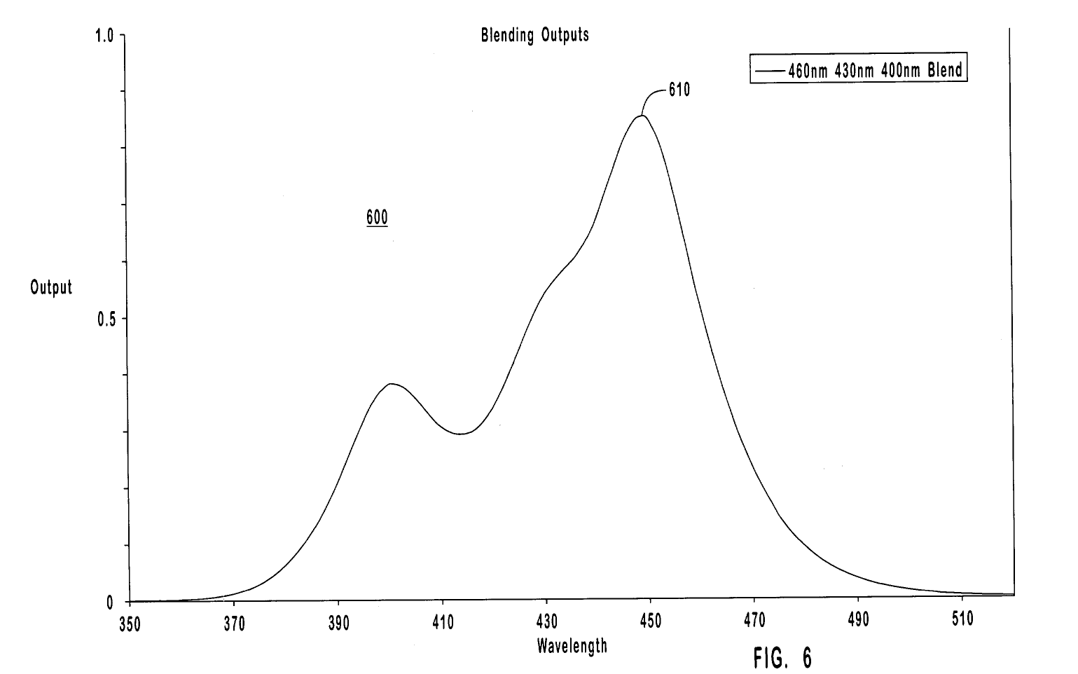

FIG. 6 illustrates a graph 600 charting the spectral irradiance of the blended light that results from emitting light from LED light sources 510, 520 and 530 at the same time. The output values given in the y-axis are generic. As shown, the spectrum 610 of light comprises a broad spectrum that emulates the spectral range of light emitted from a QTH bulb. This embodiment may be useful to eliminate the need for a practitioner to selectively turn on or off the different LED light sources between different procedures. This may also be useful when one or more products having a variety of different photo-curing requirements are cured at the same time.

To preserve the efficiency of the curing light 500, it may be desirable to only utilize LEDs that emit light that may be useful for curing photo-sensitive dental compounds. For instance, in the present embodiment, the LED light sources 510, 520, and 530 are selected to emulate a QTH bulb, rather than to simply emit any and all possible frequencies of visible light, or white light.

Notwithstanding the foregoing examples, it should be understood that the invention embraces the use of any configuration of LEDs that emit at two or more different wavelengths, preferably with the spectra emitted by at least two of the LEDs overlapping so as to yield a continuous spectrum relative to those LEDs. The overall spectrum emitted by all the LEDs may be continuous, or it may be discontinuous, although it will be preferable for at least two of the LEDs to emit a combined spectrum of light that is continuous as stated immediately above.

Non-limiting examples of LEDs that may be used within curing lights within the scope of the invention emit the following dominant or peak wavelengths: 350 nm, 370 nm, 375 nm, 380 nm, 385 nm, 393 nm, 395 nm, 400 nm, 405 nm, 410 nm, 430 nm, 450 nm, 460 nm and 465 nm.

In some cases, a relatively large number of LEDs may be used, such as 5, 10, 20, 30 or 50 or more LEDs, some or all of which emit at different wavelengths. In the case where it would be impractical to place a large number of LEDs at the end of the curing light, the light emitted by the multiple LEDs can be collected and transmitted using a standard light guide (not shown). Instead of, or in addition to a light guide, one or more lenses used to focus or collimate the light emitted by the LEDs may be used.

In summary, the curing lights of the invention are configured with a plurality of different types of light sources that are capable of emitting different light spectra that collectively comprise a broad spectrum of light. The broad spectrum of light is, in one embodiment, configured to emulate the spectrum of light emitted by a QHT bulb. In this and other embodiments, the broad spectrum is configured to cure both camphorquinone initiated products and adhesives.

It will be appreciated that the present claimed invention may be embodied in other specific forms without departing from its spirit or essential characteristics. The described embodiments are to be considered in all respects only as illustrative, not restrictive. The scope of the invention is, therefore, indicated by the appended claims rather than by the foregoing description. All changes that come within the meaning and range of equivalency of the claims are to be embraced within their scope.

What is claimed is:

1. A curing light for curing photo-sensitive dental compounds, the curing light comprising:
a body;
first and second LED light sources disposed on the body;
the first LED light source being configured to emit a first spectrum of light, the first spectrum of light being defined by a first spectral range of wavelengths; and
the second LED light source being configured to emit a second spectrum of light, the second spectrum of light being defined by a second spectral range of wavelengths that is different than the first spectral range of wavelengths,
the first and second spectral ranges of wavelengths collectively emitting a combined spectrum of light that is substantially continuous.

2. An LED curing light as recited in claim 1, wherein the first and second LED light sources are disposed on a body of the curing light and in such a manner as to enable the light emitted by the first and second LED light sources to at least partially overlap.

3. An LED curing light as recited in claim 1, wherein the combined spectrum of light emulates a spectrum of light emitted by a quartz-tungsten-halogen bulb.

4. An LED curing light as recited in claim 1, wherein the combined spectrum of light is suitable for curing both camphorquinone initiated photo-sensitive products and photo-sensitive adhesives, wherein the photo-sensitive adhesives have different photo-curing requirements than the camphorquinone initiated photo-sensitive products.

5. An LED curing light as recited in claim 1, wherein the first and second LED light sources are disposed on a body of the curing light and in such a manner as to enable the first and second LED light sources to emit the first and second light spectra to a desired treatment area within a patient's mouth and without the use of a light-guide.

6. An LED curing light as recited in claim 5, wherein the first and second LED light sources are disposed on opposing faces of the curing light and in such a manner as to direct the first and second light spectra in an orthogonal direction away from the curing light.

7. An LED curing light as recited in claim 1, wherein the first and second LED light sources collectively emit peak wavelengths selected from 350 nm, 370 nm, 375 nm, 380 nm, 385 nm, 393 nm, 395 nm, 400 nm, 405 nm, 410 nm, 430 nm, 450 nm, 460 nm and 465 nm.

8. An LED curing light as recited in claim 1, wherein the first LED light source includes a 460 nm LED and wherein the second LED light source includes a 400 nm LED.

9. An LED curing light as recited in claim 1, wherein the first LED light source includes a 460 nm LED and wherein the second LED light source includes a 430 nm LED.

10. An LED curing light as recited in claim 1, wherein the first LED light source includes a 430 nm LED and wherein the second LED light source includes a 400 nm LED.

11. An LED curing light as recited in claim 1, further including:
controls disposed upon the body for selectively controlling operation of the first and second LED light sources, such that the first and second LED light sources can be activated either singly or simultaneously as desired.

12. An LED curing light as recited in claim 1, further including a third LED light source configured to emit a third spectrum of light, the third spectrum of light being defined by a third spectral range of wavelengths that is different than the first and second spectral ranges of wavelengths, the first, second and third spectral ranges of wavelengths collectively comprising a continuous spectrum of light.

13. An LED curing light as recited in claim 1, further comprising up to 48 additional LED light sources.

14. An LED curing light as recited in claim 13, further comprising a light guide that collects light from the LED light sources and transmits it to an end of the curing light.

15. An LED curing light for curing photo-sensitive dental compounds, the LED curing light comprising:
a first LED light source configured to emit a first spectrum of light, the first spectrum of light being defined by a first spectral range of wavelengths; and
a second LED light source configured to emit a second spectrum of light, the second spectrum of light being defined by a second spectral range of wavelengths that is different than the first spectral range of wavelengths,
the first and second spectral ranges of wavelengths collectively comprising a combined spectrum of light that at least partially emulates a spectrum of light emitted by a quartz-tungsten-halogen bulb.

16. An LED curing light as recited in claim 15, wherein the first and second LED light sources are disposed on a body of the curing light in such a manner as to enable the first and second light spectra to at least partially overlap.

17. An LED curing light as recited in claim 15, wherein the first and second LED light sources are disposed on a body of the curing light and in such a manner as to enable the first and second LED light sources to emit the first and second light spectra to a desired treatment area within a patient's mouth and without the use of a light-guide.

18. An LED curing light as recited in claim 15, wherein the first LED light source includes a 400 nm LED.

19. An LED curing light as recited in claim 18, wherein the second LED light source includes either a 460 nm LED or 430 nm LED.

20. An LED curing light as recited in claim 15, further including:
a third LED light source configured to emit a third spectrum of light, the third spectrum of light being defined by a third spectral range of wavelengths that is different than both the first and second spectral ranges of wavelengths, the first, second and third spectral ranges of wavelengths collectively comprising a continuous spectrum of light;
a body upon which the first, second and third LED light sources are disposed; and
controls disposed upon the body for selectively controlling operation of the first, second and third LED light sources, such that the first, second and third LED light sources can be operated simultaneously or separately as desired.

21. An LED curing light for curing photo-sensitive dental compounds, the LED curing light comprising:
a body configured to be held by the hand of a dental practitioner;
a first LED light source configured to emit a first spectrum of light, the first spectrum of light being defined by a first spectral range of wavelengths;
a second LED light source configured to emit a second spectrum of light, the second spectrum of light being defined by a second spectral range of wavelengths that is different than the first spectral range of wavelengths; and
a third LED light source configured to emit a third spectrum of light, the third spectrum of light being defined by a third spectral range of wavelengths that is different than both the first and second spectral ranges of wavelengths,
the first, second and third spectral ranges of wavelengths collectively comprising a substantially continuous spectrum of light that emulates a spectrum of light emitted by a quartz-tungsten-halogen bulb,
wherein the first, second and third LED light sources are disposed on the body of the curing light and in such a manner as to enable the first, second and third LED light sources to emit the first, second and third light spectra to a desired treatment area within a patient's mouth and without the use of a light-guide.

22. An LED curing light as recited in claim 21, wherein the substantially continuous spectrum of light includes substantially all wavelengths in a range from about 360 nm to about 510 nm.

23. An LED curing light as recited in claim 21, wherein the first LED light source comprises a 460 nm LED, the second LED light-source comprises a 430 nm LED, and the third LED light source comprises a 400 nm LED.

24. An LED curing light as recited in claim 21, further including controls disposed upon the body for selectively controlling operation of the first, second and third LED light sources, such that the first, second and third LED light sources can be activated either singly or simultaneously as desired.
